(19) United States
(12) Patent Application Publication
(10) Pub. No.: US 2023/0278436 A1
(43) Pub. Date: Sep. 7, 2023

(54) BATTERY SET FOR ELECTRIC MOTORCYCLES AND METHOD FOR FORMING BATTERY SETS

(71) Applicant: WIN LIFE ELECTRIC VEHICLES, S.L., Barcelona (ES)

(72) Inventor: Josep LOSANTOS SISTACH, Barcelona (ES)

(21) Appl. No.: 18/005,821

(22) PCT Filed: Jul. 14, 2021
(86) PCT No.: PCT/EP2021/069605

§ 371 Date: Jan. 17, 2023

(30) Foreign Application Priority Data
Jul. 17, 2020 (EP) 20382646.6

(51) Int. Cl. B60L 50/64; B62J 43/16; B60L 50/60; H01M 50/244; H01M 50/249; B60L 58/26

(52) U.S. Cl. CPC B60L 50/64; B62J 43/16; B60L 50/66; H01M 50/244; H01M 50/249; B60L 58/26; B60L 2200/12; H01M 2220/20

(57) ABSTRACT

The battery set (1) for electric motorcycles comprises: a plurality of battery modules (4), wherein said battery modules (4) are placed in at least: a main block (2), and two side blocks (3), defining the main block (2) and the side blocks (3) a gap (5).

The method for forming battery sets includes the steps of flat welding a plurality of battery modules (4) to each other; and folding at least one of the battery modules (4) with respect to the adjacent battery module (4), after welding.

It allows optimizing the arrangement of the battery assembly in a motorcycle, so that the volume normally used in the combustion engine and the exhaust in conventional motorcycles is used.

The present invention relates to a battery set for electric motorcycles and to a method for forming battery sets.

### BACKGROUND OF THE INVENTION

Vehicles traditionally comprise internal combustion engines for operation.

However, due to the contamination generated by these types of motors, the use of electric or hybrid vehicles is becoming more common.

One of the problems of electric vehicles is their limited autonomy due to the capacity of their batteries.

The batteries of electric vehicles form sets of battery modules connected to each other, and have the drawback of their volume and weight.

These battery sets usually have a square or rectangular box shape.

In the case of motorcycles, these drawbacks are even greater, since the space available to place these battery sets in the form of a square or rectangular plan box is limited, so that the autonomy of electric motorcycles is very limited.

Furthermore, depending on the position where this battery set is placed, it can affect the center of gravity of the motorcycle, with the consequent increase in the risk of accidents due to its stability.

### DISCLOSURE OF THE INVENTION

Therefore, an objective of the present invention is to provide a battery set that optimizes its placement on a motorcycle.

With the battery set of the invention said disadvantages are solved, presenting other advantages that will be described below.

The battery set for electric motorcycles according to the present invention comprises:
a plurality of battery modules,
   wherein
   said battery modules are arranged in at least:
a main block, and
two side blocks,
   said main block and said lateral blocks defining a gap.

Thanks to this feature, the arrangement of the battery set in a motorcycle is optimized, so that the volume that normally occupies the combustion engine and the exhaust in conventional motorcycles is used.

Said gap defined by the main block and the side blocks allows the positioning of the rear wheel of the motorcycle between the side blocks.

According to a preferred embodiment, said main and lateral blocks define a U-shaped plan.

Preferably, the battery modules in each side block are positioned in a plurality of columns and one row, such that each side block is elongated in shape, allowing it to be positioned extending along the rear wheel of the motorcycle.

Preferably, the battery modules in the main block are positioned forming a plurality of columns and a plurality of rows, so that the main block has square or rectangular plan, being able to be placed in front of the rear wheel of the motorcycle.

Furthermore, said battery modules can also be arranged in transition blocks placed between the main block and each side block, and each transition block being preferably placed diagonally between the main block and a side block.

According to a preferred embodiment, each battery module comprises connecting plates for joining the batteries, and each connecting plate comprises a plurality of housings for housing one end of a battery, each housing comprising an anchoring hook.

Furthermore, the battery set for electric motorcycles according to the present invention comprises connections which are advantageously protected by a sliding safety cover.

These connections can be of two types, power (high voltage) and signal. The sliding cover covers the signal or power connection, but not both simultaneously. To connect the power cables to the power connection, the connector to the signal connection must be removed, since, if fitted, the connector itself would prevent the cover from moving and expose the power connection.

In addition, when removing the connector from the signal connection, the set is completely disconnected, without voltage in the power connection. In this situation, it is possible to slide the cover and act on the power connector without danger. Thus, to connect the signal connection and put the power connection in tension, it is essential to move the sliding cover and cover the power connection.

Furthermore, the battery set for electric motorcycles according to the present invention advantageously comprises a cooling window, preferably placed in its lower part.

The battery set for electric motorcycles according to the present invention also comprises an inverter and a DC-DC converter integrated in the battery pack itself.

According to a second aspect, the present invention also refers to a method for forming battery sets as described above, comprising the steps of:
flat welding a plurality of battery modules together; and
folding at least one of the battery modules with respect to the adjacent battery module, after welding.

### BRIEF DESCRIPTION OF THE DRAWINGS

For better understanding of what has been disclosed, some drawings in which, schematically and only by way of a non-limiting example, a practical case of embodiment is shown.

FIG. 1 is a perspective view of the battery set according to the present invention;

FIG. 2 is a perspective view of the battery set according to the present invention in longitudinal section, where the battery modules can be seen;

FIG. 3 is a schematic side elevation view of a motorcycle incorporating the battery set according to the present invention;

FIG. 4 is a perspective view of the battery set according to the present invention, showing the safety cover that covers the power connection and leaves the signal connection uncovered;

FIG. 5 is a perspective view of the battery set according to the present invention, showing the safety cover that covers the signal connection and leaves the power connection uncovered;

FIG. 6 is a bottom perspective view of the battery set according to the present invention, showing the cooling window;

FIG. 7 is a perspective view of the battery set according to the present invention, where its interior is shown, and where the integration of the batteries, the inverter and the DC-DC converter can be seen;

FIG. 8 is a perspective view of a connecting plate of a battery module and a battery;

FIG. 9 is a perspective view of a plurality of battery modules during their flat welding; and

FIG. 10 is a perspective view of a plurality of battery modules during folding of a battery module with respect to adjacent battery modules.

### DESCRIPTION OF A PREFERRED EMBODIMENT

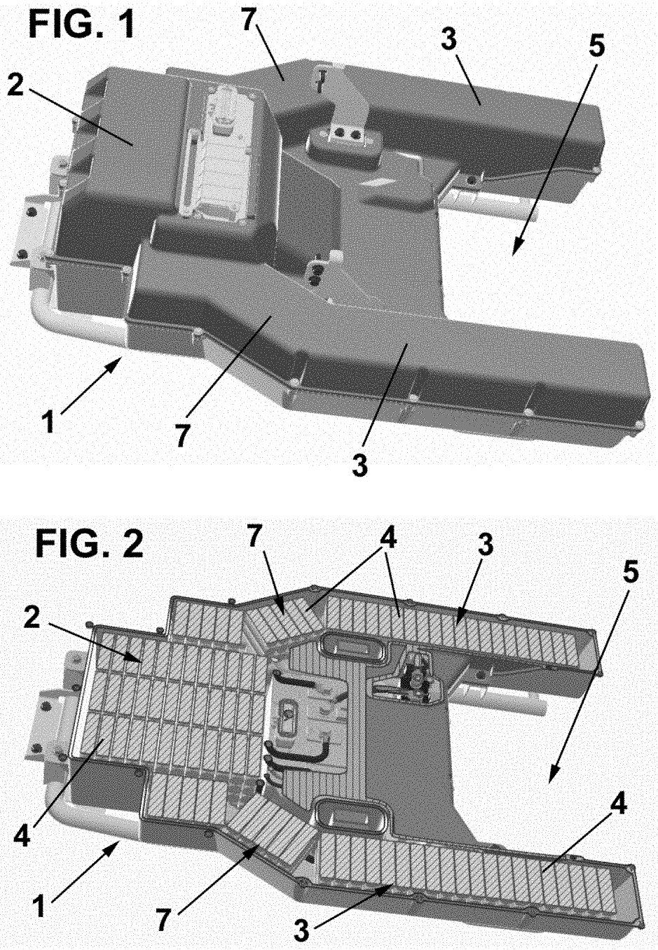

As shown in FIGS. 1 and 2, the battery set according to the present invention, generally identified by reference number 1, is divided into different blocks, in particular into a main block 2 and two side blocks 3.

Each of these blocks 2, 3 comprises within it a plurality of battery modules 4, which are those that provide electricity to an electric motorcycle.

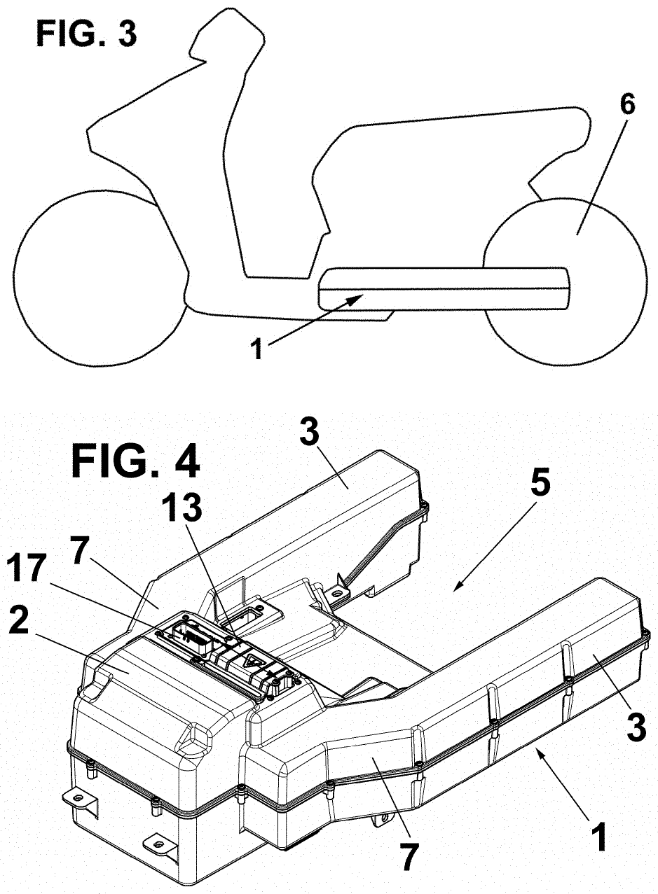

The main block 2 and the side blocks 3 are placed with each other defining a gap 5, in which a wheel 6 of a motorcycle is placed, in particular a rear wheel 6, as can be seen in FIG. 3.

That is, the main block 3 and the side blocks 3 define, in a plan view, a U-shape, which allows the battery set 1 to be placed with the side blocks 3 next to the rear wheel 6 of the motorcycle and the block main 2 in front of said rear wheel 6 of the motorcycle.

As can be seen in FIG. 2, the battery modules 4 are arranged in a plurality of rows and columns in the main block 2, while they are arranged in a single row and a plurality of columns in the side blocks 3.

This allows the proper configuration of each block. Specifically, a square or rectangular configuration for the main block 2 and an elongated configuration for the side blocks 3.

As can also be seen in FIGS. 1 and 2, between the main 2 and side 3 blocks there are transition blocks 7, placed diagonally between the main block 2 and each side block 3.

Furthermore, as can be seen in FIG. 3, the battery assembly according to the present invention is placed in a lower position of the motorcycle, so that its weight favorably affects the lowering of the center of gravity of the motorcycle as a whole.

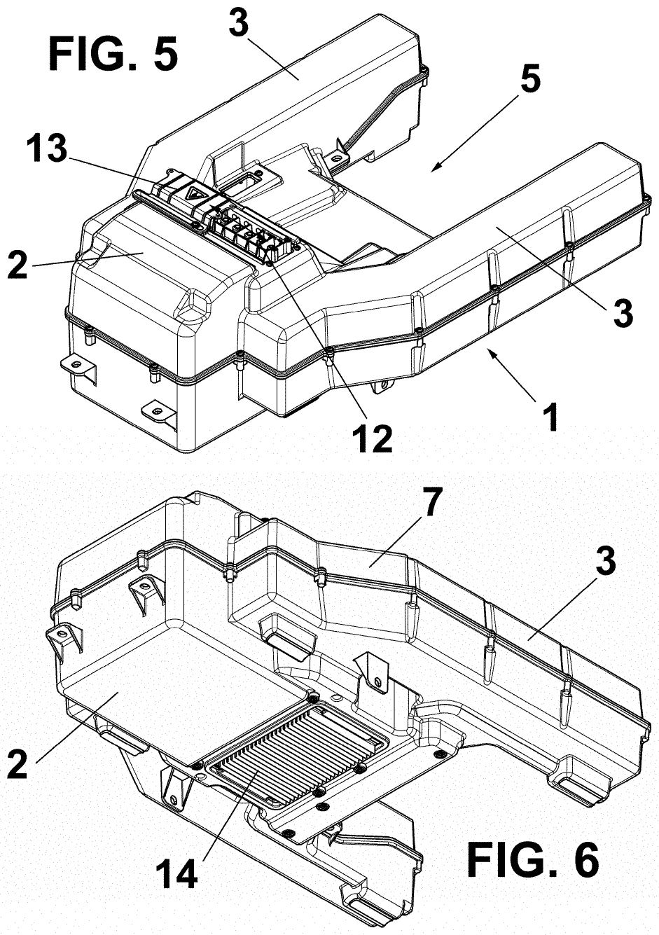

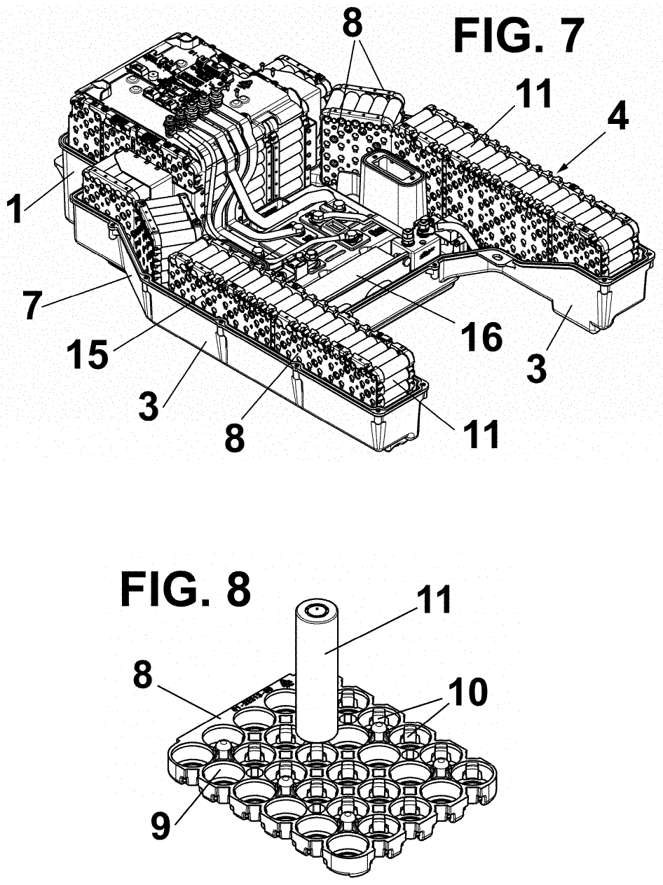

As can be seen in FIGS. 4 and 5, the battery set for electric motorcycles according to the present invention comprises a power connection 12 and a signal connection 17 that are protected by a safety cover 13 that is slidable, so that you can cover one or the other of the connections 12, 17 simply by sliding the safety cover 13.

That is, the sliding cover 13 covers the power connection 12 (FIG. 4) or the signal connection 17 (FIG. 5), but not both simultaneously. To connect the power cables to the power connection 12, the connector to the signal connection 17 must be removed, since, if fitted, the connector itself would prevent the cover 13 from moving and leave the power connection 12 uncovered.

Furthermore, by removing the connector from the signal connection 17, the set is completely disconnected, with no voltage at the power connection 12. In this situation, it is possible to slide the cover 13 and act on the power connector 12 without danger. Thus, to connect the signal connection 17 and put the power connection 12 in tension, it is essential to move the sliding cover 13 and cover the power 12 connection.

Furthermore, as shown in FIG. 6, the battery set for electric motorcycles according to the present invention comprises a cooling window 14 for cooling the battery modules 4 and the internal components.

Advantageously, the battery set for electric motorcycles according to the present invention also comprises an inverter 15 and a DC-DC converter 16 that are integrated in the battery assembly 1 itself, as shown in FIG. 6, their connection being by means of connectors.

To facilitate the assembly of the battery modules 4, each battery module 4 preferably comprises connecting plates 8 for the connection of the batteries 11, one of which is shown in FIG. 8. In each battery module 4 there will be two connecting plates 8, one upper and one lower.

Furthermore, each connecting plate 8 comprises a plurality of housings 9, preferably cylindrical, to house one end of a battery 11, each housing 9 comprising an anchoring hook 10 to retain the end of the battery 11 inside.

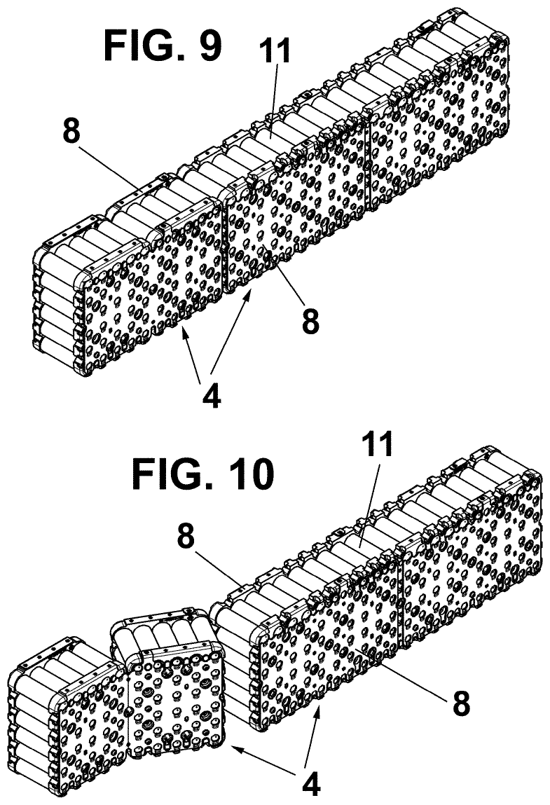

The present invention also refers to a method for forming battery sets as described above, comprising the steps of:
flat welding a plurality of battery modules 4 together, as shown in FIG. 8; and
folding at least one of the battery modules 4 with respect to the adjacent battery module 4, or relative to the adjacent battery modules 4, after welding, as shown in FIG. 9.

Although reference has been made to specific embodiments of the invention, it is apparent to a person skilled in the art that the described battery set is susceptible of numerous variations and modifications, and that all the details mentioned can be replaced by other technically equivalents, without departing from the scope of protection defined by the appended claims.

1. A battery set for electric motorcycles, comprising:
a plurality of battery modules, wherein said battery modules are placed in at least:
a main block, and
two side blocks, wherein the main block and the side blocks define a gap.

2. The battery set for electric motorcycles according to claim 1, wherein the main block and the side blocks define a U-shaped plan.

3. The battery set for electric motorcycles according to claim 1, wherein the side blocks have an elongated shape.

4. The battery set for electric motorcycles according to claim 1, wherein the battery modules in each side block are positioned forming a plurality of columns and one row.

5. The battery set for electric motorcycles according to claim 1, in which the main block has a rectangular plan.

6. The battery set for electric motorcycles according to claim 1, wherein the battery modules in the main block are positioned forming a plurality of columns and a plurality of rows.

7. The battery set for electric motorcycles according to claim 1, wherein said battery modules are also placed in transition blocks between the main block and each of the side blocks.

8. The battery set for electric motorcycles according to claim 7, wherein each of the transition blocks is placed diagonally between the main block and one or more of the side blocks.

9. The battery set for electric motorcycles according to claim 1, wherein each battery of the battery modules comprises connecting plates for joining the batteries.

10. The battery set for electric motorcycles according to claim 9, wherein each of the connecting plates comprises a plurality of housings for housing one end of a battery, each housing comprising an anchor hook.

11. The battery set for electric motorcycles according to claim 1, further comprising:
a power connection and a signal connection that are protected by a sliding safety cover, which is placed on one of said connections, leaving the other of said connections free.

12. The battery set for electric motorcycles according to claim 1, further comprising:
a cooling window.

13. The battery set for electric motorcycles according to which also comprises claim 1, further comprising:
an inverter and a DC-DC converter integrated in the battery set.

14. A method for forming battery sets, which includes the steps of:
flat welding a plurality of battery modules to each other; and
folding at least one of the battery modules with respect to an adjacent battery module, after flat welding.
